(19) United States
(12) Patent Application Publication
(10) Pub. No.: US 2014/0251379 A1
(43) Pub. Date: Sep. 11, 2014

(54) FIRE MAIN CLEANING APPARATUS AND METHOD

(71) Applicant: PARADIGM FLOW SERVICES LIMITED, Aberdeen, Aberdeenshire (GB)

(72) Inventor: Hugh Mackenzie, Aberdeenshire (GB)

(73) Assignee: Paradigm Flow Services Limited, Aberdeen, Aberdeenshire (GB)

(21) Appl. No.: 14/349,827

(22) PCT Filed: Oct. 5, 2012
(86) PCT No.: PCT/GB2012/052467

§ 371 Date: Apr. 4, 2014

(30) Foreign Application Priority Data
Oct. 5, 2011 (GB) 1117177.4

(51) Int. Cl. B08B 9/032

(52) U.S. Cl. CPC B08B 9/0321
USPC 134/18; 134/22.11; 134/169 C; 134/115 R

(57) ABSTRACT

An apparatus for and method of cleaning a fire main associated with a deluge system. The method comprises injecting a chemical treatment fluid into the fire main via a first inlet and causing it to flow along a section of the fire main and out through an outlet while the fire main is in an operative condition associated with a deluge system. In one aspect, the method comprises biociding the fire main with a solution of chlorine dioxide to treat or remove tuberculation from the fire main.

The present invention relates to an apparatus for and method of cleaning a fire main, in particular to an apparatus for and method of cleaning a fire main in an industrial facility. The invention has particular but not exclusive application to cleaning fire mains associated with deluge systems in offshore installations and vessels, such as installations and vessels used in the offshore hydrocarbon exploration and production industry.

### BACKGROUND TO THE INVENTION

Conventional fire sprinkler systems are used widely in industrial facilities, commercial properties, and increasingly in homes, as an active fire protection measure. A water supply is connected to a network of sprinklers, generally situated overhead, which are held closed until activated. Activation is usually by way of a heat sensitive element within one or more sprinklers reacting to ambient temperature exceeding an activation temperature, whereupon the sprinklers are opened and the water flows therethrough to extinguish the fire.

Water deluge systems are specifically designed to extinguish fires by dispensing a large volume of water over an entire hazard area. Accordingly, while water deluge systems are similar to conventional fire sprinkler systems, in a water deluge system all of the sprinklers or nozzles are open. As a consequence, water is not present in the piping system until activated. The piping system is filled with air at atmospheric pressure which is lower than the water pressure of a fire main coupled to the deluge system; however water is prevented from entering the deluge system, until required, by a deluge valve. An example of fire protection system is presented schematically in FIG. 1 generally depicted at 1. The system 1 comprises a ring fire main 2 coupled to a deluge system 3 via a deluge valve 4. The fire main is connected to a source of water (not shown) by a fire pump 5. The fire main 2 is oriented in a loop to provide flow path redundancy to the deluge system 3. At locations along the fire main 2, hydrants 6 provide outlets to the fire main. The deluge system comprises a network of pipes 7 comprising a number of nozzles 8 distributed throughout the pipes.

The deluge valve 4 is controlled by the control system 9 to open in an emergency condition and flood the deluge system. The fire main is fully flooded in an operative condition, and has a steady pressure of about 6 bar (600 kPa) when the fire pump is not running. Should pressure sensors in the fire main detect a drop in the fire main pressure to below a predetermined threshold (around 4 bar (400 kPa)), then the fire pump will be activated in order to increase the fire main pressure to its normal level. Optionally, the fire main may include a jockey pump, which is designed to keep water in the fire main flowing at a low flow rate which prevents the water from freezing in the pipe work. Water deluge systems are usually activated automatically by a fire alarm system (manual activation mechanisms are usually also provided) which controls the deluge valve; when the deluge valve is opened water enters the piping system and is subsequently dispensed over the hazard area via the open sprinklers or nozzles. The deluge valve stays open until closed. Water deluge systems must be properly maintained and nozzles, and the associated pipe work, must be kept clear to ensure the system will work effectively. A poorly maintained deluge system may be unable to deposit a sufficient volume of water to extinguish a fire and as a result lead to rapid fire escalation which puts lives at risk and can cause catastrophic damage to assets.

For example, a marine or offshore deluge system is coupled to a fire main, through which seawater is discharged. The fire main may contain deposits of sand, salt and marine growth, and over time potentially severe microbiological tuberculation. Tuberculation is characterised by the formation of reddish brown mounds of material attached to the interior of pipe wall, formed to varying heights. The mounds (or tubercles) are the result of many years of bio-fouling, in which biofilms develop on the wetted surface of a pipe. The bacterial growth deposits iron and/or manganese oxides along with particulate matter from the water, which become trapped in the biomass from generations of bacteria. Tuberculation built up in the fire main restricts the flow of fluid through the fire main and into the deluge system, which reduces its effectiveness in an emergency situation. Furthermore, when the deluge system is activated the contaminants from the fire main are transported throughout the pipe work and become deposited throughout the system. These deposits (and other existing deposits) can be loosened and as a result nozzles can be blocked, significantly affecting the efficacy of the deluge system. Although chemical treatment methods, for example flushing and acid cleaning techniques and high pressure retro-jetting techniques are conventionally used for cleaning deluge systems downstream of the deluge valve, even a clean deluge system may be prone to rapid re-contamination and deposition of contaminants because the water used to flush the deluge system or even the water used in deluge operations (even during testing or drills) may be polluted or contaminated.

The application of conventional methodologies to the maintenance of fire mains presents a number of problems. The systematic replacement of pipe work and valves is inefficient and expensive. Jet cleaning techniques used in other pipe cleaning applications may be capable of removing tuberculation, but relies on a sufficiently large entry point to the fire main system. Often this will not be available; older fire main systems may have isolation valves in poor condition which makes isolation difficult and/or unreliable. Replacement of isolation valves to provide an entry point is difficult and time consuming due to access restrictions and the sheer size and weight of the valves. Pipe freezing methods to enable valves to be changed out are expensive and slow. There is therefore a need for an apparatus for and method of cleaning existing fire main pipe work which does not suffer from these drawbacks.

For safety reasons, normal operations of an offshore installation or vessel are often disrupted or ceased if it is necessary to take a deluge system offline for maintenance or cleaning. Given the cost of operating an asset, for example several hundred thousand US$ per day for a drilling platform that may have a dozen or more deluge systems, cessation of operations can lead to significant loss of revenue. It is therefore desirable to be able to clean or maintain fire mains associated with deluge systems without having to take the water deluge system offline.

U.S. Pat. No. 5,360,488 describes a system for treating an isolated section of a water distribution system such as a water main, by the circulation of a cleaning solution through access points including a fire hydrant. U.S. Pat. No. 5,800,629 describes a process for pipe system cleaning, using apparatus as described in U.S. Pat. No. 5,360,488, in which a cleaning solution is added to a fouled pipe system to clean the pipe system of scale or deposits. US 2005/0150520 and U.S. Pat. No. 6,345,632 describe methods of treating isolated or offline pipeline systems with biocides.

The approaches described in the prior art require isolation of a pipeline section being treated. This limits their application to the treatment of a fire main which is associated with a deluge system and which is maintained in an online condition to avoid cessation of operations.

It is therefore an object of at least one embodiment of an aspect of the present invention to provide an apparatus for effective and efficient cleaning of a fire main associated with a water deluge system and a corresponding method.

It is also an object of at least one embodiment of an aspect of the present invention to provide an apparatus for and method of cleaning a fire main associated with a water deluge system which may be performed while the associated deluge system is online.

It is a further object of at least one embodiment of an aspect of the present invention to provide an apparatus for and method of cleaning a fire main associated with a water deluge system which may be practiced in a wide range of industrial facilities, including offshore installations and vessels such as those used in the oil and gas industry. Additional aims and objects of the invention will become apparent from reading the following description.

### SUMMARY OF THE INVENTION

According to a first aspect of the invention, there is provided a method of cleaning a fire main associated with a deluge system, the method comprising: coupling a fluid injection subsystem and a fluid collection subsystem respectively to an inlet and an outlet of a first pair of access points to the fire main; injecting a chemical treatment fluid into the fire main and causing it to flow along a first section of the fire main via the inlet and outlet of the first pair of access points while the fire main is in an operative condition associated with a deluge system.

The term “in an operative condition associated with a deluge system” means that the fire main is online and/or may be fired or actuated to flood the deluge system. In other words, the fire main is flooded with water, and is at an operating pressure which is above atmospheric pressure (about 100 kPa). Treating the fire main while the fire protection system is online allows treatment to take place without disruption (or reduced disruption) to normal operations in an industrial facility. This is a particularly significant advantage in applications to industrial facilities which have high operating expense, such as installations (onshore and offshore) for the hydrocarbon exploration and production industry.

Preferably, at least one of the inlet and outlet of the first pair of access points is a fire main hydrant access point. The fire main access point may be a fire main hydrant itself; a component thereof or a partially disassembled component thereof; or a coupling point of the fire main at which a hydrant is mounted or designed to be mounted in normal use. The inventors have appreciated that a fire main hydrant access point may be utilised for chemical treatment injection to provide significant operational benefits.

Preferably, the fire main access point is associated with a fire main isolation valve. The method may comprise coupling to the access point; isolating the fluid injection or collection subsystem from the access point by closing an isolation valve in the fluid injection or collection subsystem; and/or opening an access point isolation valve.

Preferably, the method comprises pumping the chemical treatment fluid into the fire main, and/or may comprise choking the flow into the fluid collection subsystem from the outlet. The method may comprise pressurising the fluid injection and/or collection subsystem to a pressure above the operational pressure in the fire main, prior to fluidly connecting the fluid injection and/or collection subsystem to the fire main.

The chemical treatment fluid may comprise a biocide, and therefore the method may comprise biociding the fire main or a section of the fire main. The biocide may comprise a solution of chlorine dioxide. Preferably the method includes generating chlorine dioxide and spiking an injection fluid to form a chlorine dioxide solution. By creating a chlorine dioxide solution in-situ, difficulties associated with the storage of chlorine dioxide may be avoided.

The use of chlorine dioxide solution as a biocide in preferred embodiments of the invention is particularly advantageous in applications to the treatment of a fire main in an online condition. In particular, chlorine dioxide solution provides a suitably aggressive treatment for the material typically found in a fire main system, with a low risk of adverse effects on personnel, infrastructure or equipment in the event that the associated deluge system needs to be activated during a treatment operation. The chlorine dioxide solution may be conveniently produced using a chlorine dioxide generation unit to avoid transport and storage of pre-prepared chemical treatment solutions.

The method may comprise soaking the first section of the fire main with the chemical treatment fluid. Preferably, the method comprises isolating the fluid injection subsystem and the fluid collection subsystem at the inlet and the outlet of the first pair of access points, while the chemical treatment is in the fire main.

The method may comprise flushing the fire main or a section of the fire main after injection of a chemical treatment fluid. Flushing may comprise activating a fire pump associated with the fire main to pump water through the fire main to a discharge outlet.

The method may comprise operating a choke in the fluid collection subsystem to control fluid pressure during injection of the chemical treatment fluid into the fire main.

The method may comprise repeating the injection of a chemical treatment fluid into the fire main (i.e. performing a second injection of chemical treatment fluid). Preferably, a second injection of the chemical treatment fluid is performed at a lower dose than the first injection of a chemical treatment fluid. The injection of a chemical treatment fluid may be repeated for an additional one or more times at successively lower doses than previous chemical treatment fluid injections.

Where the chemical treatment injection fluid is chlorine dioxide, a first injection dose may be greater than 40 ppm chlorine dioxide in solution. A second injection dose may be in the range of 20 to 50 ppm chlorine dioxide in solution. A third or subsequent does may be less than 30 ppm chlorine dioxide in solution.

The method may comprise passing a debris pick-up gel through the first section of the fire main. Preferably, the method comprises pumping a debris pick-up gel from a gel storage tank through the first section of the fire main to a waste collection tank in the fluid collection subsystem. The gel may be a cross-linked gel, and the method may comprise injecting a gel cross-linking agent into the fire main.

The method may comprise coupling a fluid injection subsystem and a fluid collection subsystem respectively to an inlet and an outlet of a second pair of access points to the fire main; and injecting a chemical treatment fluid into the fire main causing it to flow along a second section of the fire main via the inlet and outlet of the second pair of access points. The invention may therefore provide a method by which a fire main may be cleaned by sequential treatment of sections. The first and second sections may be adjacent sections in the fire main, or may overlap in the fire main.

Preferably, at least one of the inlet and outlet of the second pair of access points is a fire main hydrant access point.

Preferably, the method comprises removing tuberculation from the interior of the fire main.

The method may comprise circulating fluid collected from the fluid collection subsystem into the fluid injection subsystem.

The method may comprise inserting a camera into a section of the fire main and visually monitoring the chemical treatment process or results of the chemical treatment.

According to a second aspect of the invention, there is provided a method of cleaning a fire main associated with a deluge system, the method comprising:

coupling a fluid injection subsystem and a fluid collection subsystem respectively to an inlet and an outlet of a first pair of access points to the fire main;

injecting a chemical treatment fluid into the fire main and causing it to flow along a first section of the fire main via the inlet and outlet of the first pair of access points;

coupling a fluid injection subsystem and a fluid collection subsystem respectively to an inlet and an outlet of a second pair of access points to the fire main;

injecting a chemical treatment fluid into the fire main and causing it to flow along a second section of the fire main via the inlet and outlet of a second pair of access points.

The method may comprise injecting a chemical treatment fluid into the fire main while the fire main is in an operative condition associated with a deluge system.

The chemical treatment fluid may comprise a biocide, and therefore the method may comprise biociding the fire main or a section of the fire main. The biocide may comprise a solution of chlorine dioxide.

Embodiments of the second aspect of the invention may comprise essential, optional or preferred features of the first aspect of the invention or vice versa.

According to a third aspect of the invention, there is provided a method of cleaning a fire main associated with a deluge system, the method comprising:

coupling a fluid injection subsystem and a fluid collection subsystem respectively to an inlet and an outlet of a first pair of access points to the fire main;

injecting a chemical treatment fluid into the fire main and causing it to flow along a first section of the fire main via the inlet and outlet of the first pair of access points;

wherein at least one of the first pair of access points comprises a fire main hydrant access point.

The method may comprise injecting a chemical treatment fluid into the fire main while the fire main is in an operative condition associated with a deluge system.

The method may comprise:

coupling a fluid injection subsystem and a fluid collection subsystem respectively to an inlet and an outlet of a first pair of access points to the fire main;

injecting a chemical treatment fluid into the fire main and causing it to flow along a first section of the fire main via the inlet and outlet of the first pair of access points;

coupling a fluid injection subsystem and a fluid collection subsystem respectively to an inlet and an outlet of a second pair of access points to the fire main;

injecting a chemical treatment fluid into the fire main and causing it to flow along a second section of the fire main via the inlet and outlet of a second pair of access points.

The chemical treatment fluid may comprise a biocide, and therefore the method may comprise biociding the fire main or a section of the fire main. The biocide may comprise a solution of chlorine dioxide.

Embodiments of the third aspect of the invention may comprise essential, optional or preferred features of the first or second aspects of the invention or vice versa.

According to a fourth aspect of the invention, there is provided a method of cleaning a fire main associated with a deluge system, the method comprising: injecting a solution of chlorine dioxide into the fire main and collecting effluent from an outlet to the fire main.

The method may comprise injecting a chemical treatment fluid into the fire main while the fire main is in an operative condition associated with a deluge system.

The method may comprise:

coupling a fluid injection subsystem and a fluid collection subsystem respectively to an inlet and an outlet of a first pair of access points to the fire main;

injecting a chemical treatment fluid into the fire main and causing it to flow along a first section of the fire main via the inlet and outlet of the first pair of access points;

coupling a fluid injection subsystem and a fluid collection subsystem respectively to an inlet and an outlet of a second pair of access points to the fire main;

injecting a chemical treatment fluid into the fire main and causing it to flow along a second section of the fire main via the inlet and outlet of a second pair of access points.

Embodiments of the fourth aspect of the invention may comprise essential, optional or preferred features of the first to third aspects of the invention or vice versa.

According to a fifth aspect of the invention is a method of removing tuberculation from a fluid conduit, the method comprising:

injecting a solution of chlorine dioxide into a first section of the fluid conduit and collecting effluent from the first section;

injecting a solution of chlorine dioxide into a second section of the fluid conduit and collecting effluent from the second section.

Embodiments of the fifth aspect of the invention may comprise essential, optional or preferred features of the first to fourth aspects of the invention or vice versa.

According to a sixth aspect of the invention there is provided a system for treating a fire main associated with a deluge system, the system comprising:

a fluid injection subsystem and a fluid collection subsystem operable to be coupled respectively to an inlet and an outlet of a fire main while the fire main is in an operative condition associated with a deluge system;

a pump for injecting a chemical treatment fluid into the fire main and causing it to flow along in the fire main from the fluid injection subsystem to the fluid collection subsystem.

Preferably, the fluid injection subsystem and/or the fluid collection subsystem are operable to be coupled to a fire main hydrant access point.

Preferably, the fluid injection subsystem and/or collection subsystem comprise an isolation valve.

Preferably, the fluid collection subsystem comprises a choke, which may function to choke the flow into the fluid collection subsystem from the outlet.

Preferably the fluid injection subsystem comprises a biocide injection unit, which may be a chlorine dioxide injection unit. The chlorine dioxide injection unit may comprise a chlorine dioxide generator.

Preferably the system comprises a debris pick-up gel injection means, and may further comprise a debris pick-up gel collection means. The fluid injection subsystem may comprise means for injecting a gel cross-linking agent into the fire main.

The system may comprise a camera configured to be inserted into the fire main.

Embodiments of the sixth aspect of the invention may comprise essential, optional or preferred features of the first to fifth aspects of the invention or vice versa.

### BRIEF DESCRIPTION OF THE DRAWINGS

There will now be described, by way of example only, various embodiments of the invention with reference to the drawings, of which:

FIG. 1 is a schematic view of a fire protection system according to the prior art;

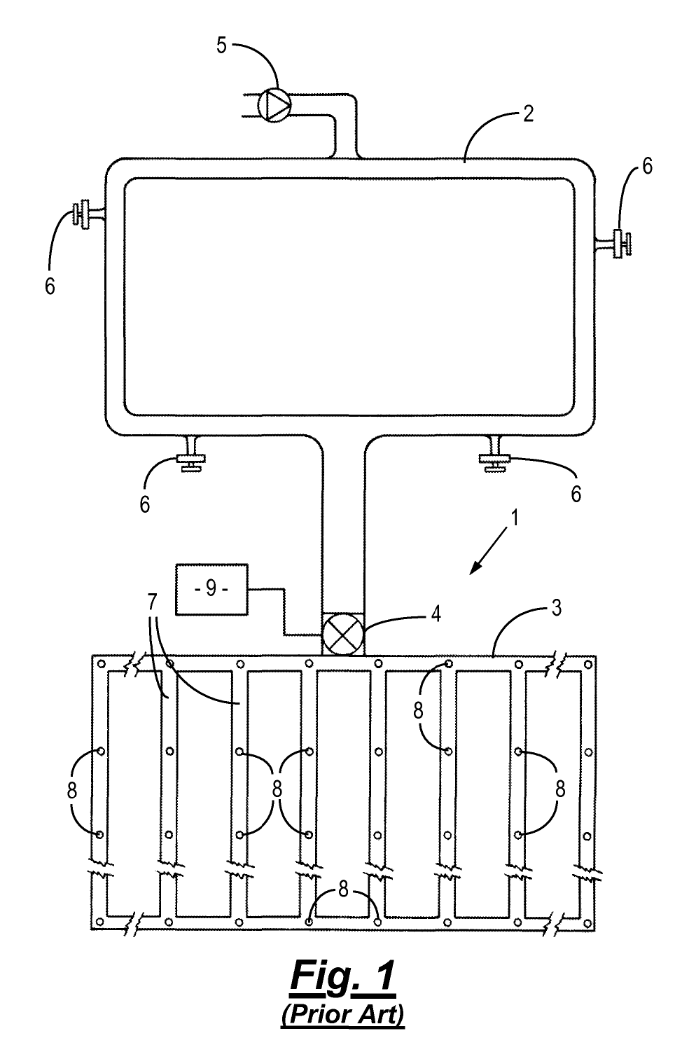

FIG. 2 is a schematic view of a fire protection system, on which embodiments of the invention may be used;

FIG. 3 is a schematic view of a fire main and fire main hydrant as used in accordance with embodiments of the invention;

FIG. 4 is a process flow diagram of a fire main cleaning system in accordance with an embodiment of the invention;

FIG. 5 is a block diagram showing a simplified method of cleaning a fire main in accordance with an embodiment of the invention.

### DETAILED DESCRIPTION OF PREFERRED EMBODIMENTS

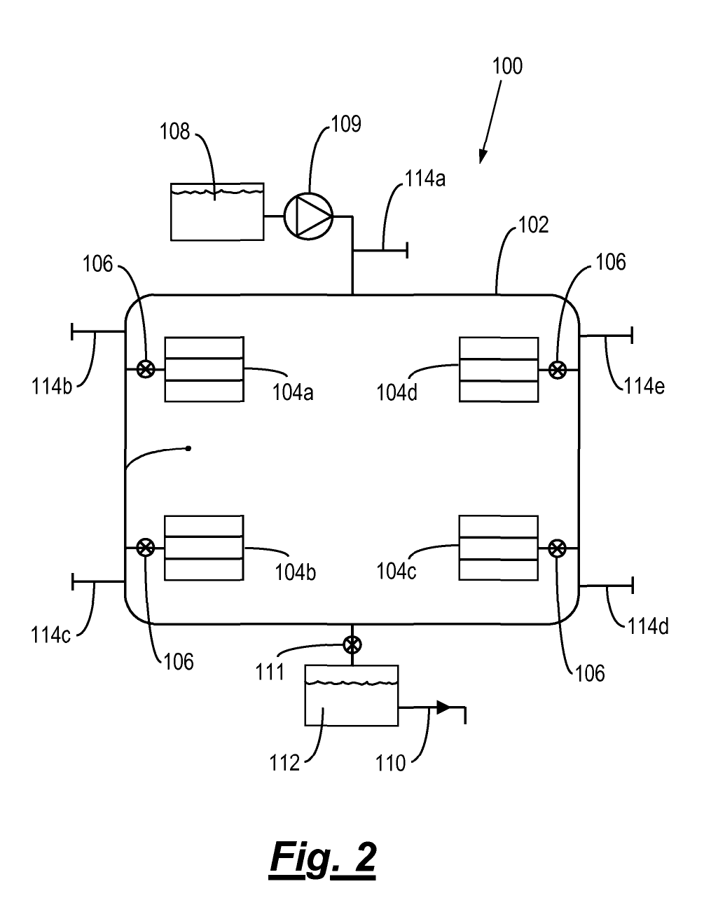

FIG. 2 shows schematically a fire protection system 100 comprising a fire main 102 and a plurality of deluge systems 104a, 104b, 104c and 104d via corresponding deluge valves 106. The fire main 102 is oriented as a loop, to provide redundancy in the flow path to any particular deluge system from the water source 108. The fire main is also provided with an overboard dump outlet 110 through an intermediate holding tank 112. The fire main 102 comprises a number of hydrants 114a to 114e located at different positions around the fire main, and which function in normal use to provide attachment points around the installation for fire hoses (not shown). The fire protection system 100 is illustrative of fire protection systems of offshore installations such as those used in the oil and gas exploration and production industry. However, it will be appreciated that the invention may be used with fire protection systems with different configurations and in different applications.

Before beginning a cleaning or maintenance operation, it is necessary to identify suitable tie-in points through which the fire main 102 can be accessed. This is not trivial, particularly in the case of aging assets which present external access problems and which may have valves and pipe work in poor condition. The inventors have appreciated that by taking a chemical injection treatment approach, the difficulties of access are mitigated compared with, for example, mechanical cleaning methods used in other pipe cleaning applications.

It has also been appreciated by the inventors that the fire main hydrants, or at least a subset of the fire main hydrants, provide suitable access points for a chemical injection treatment. In preferred embodiments, the apparatus and methods of the invention couple into the fire main hydrants in order to inject chemical treatment fluids into a section of the fire main, and/or couple into the fire main hydrants to provide outlets for the chemical treatment fluids and materials dislodged from the fire main. The use of a fire main hydrant provides several operational advantages and benefits as will be apparent from the following description.

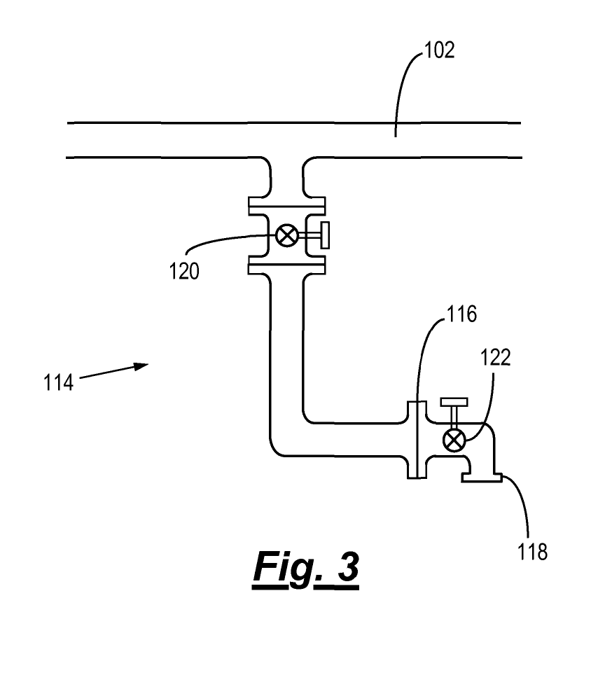

A typical fire main hydrant 114 is shown schematically in FIG. 3, coupled to a fire main 102. The hydrant 114 comprises an isolation valve 120 connected into the fire main 102, and an extension piece 121 terminating with a raised face flange 116. The isolation valve 120 allows the hydrant to be shut off from the fire main. Coupled to the raised face flange 116 is a connection 118 for attachment of a fire hose (not shown) usually referred to as a “Quick Connect”. An isolation valve 122 in the connection 118 downstream of the flange coupling 116 allows a connected fire hose to be shut off from the fire main. Within the hydrant 114 is a hydrant isolation valve 122 which functions in use to control the flow from the hydrant to a fire hose.

The fire main hydrants 114 do not provide a suitable access point for mechanical cleaning tools, due to the ends in the pipe work and the narrow passages of the isolation valves. However, the inventors have appreciated that the hydrants may be used to provide an inlet for a chemical injection treatment. However, in many fire main systems this would not be apparent as the connections 118 may not provide a suitably reliable and leak free tie-in point. In preferred embodiments of the invention, hydrants with operational isolation valves 120 located upstream of the flange coupling 116 are identified and utilised. This allows the connection 118 to be removed from the raised face flange coupling to provide a suitable access point at the through the upstream isolation valve 120 and into the fire main.

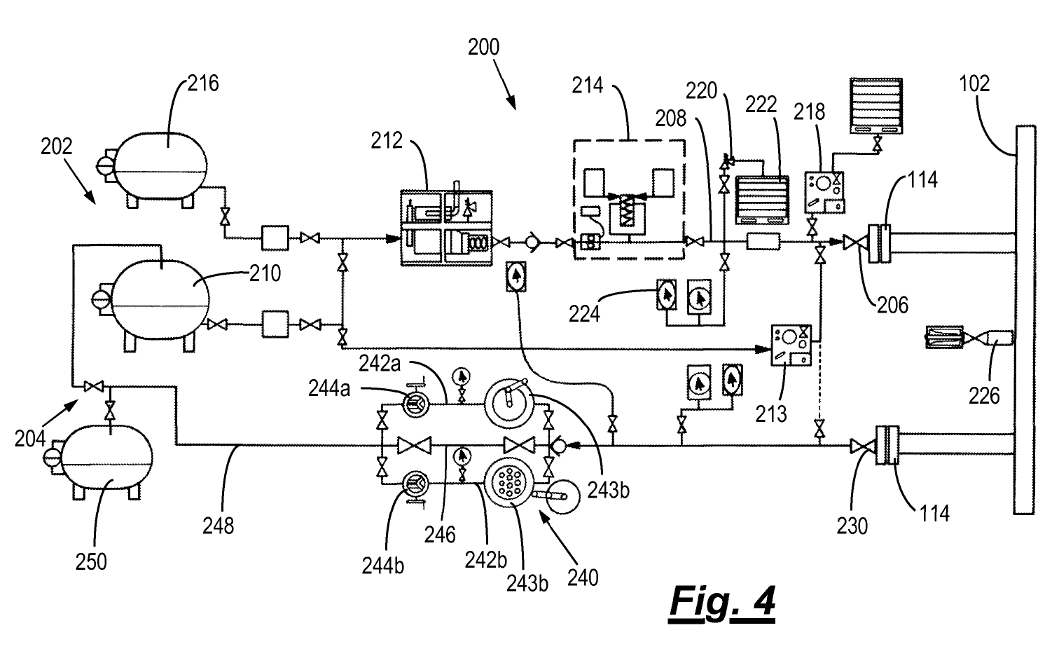

FIG. 4 shows schematically a cleaning system 200, according to an embodiment of the invention. The cleaning system 200 includes an upstream subsystem, generally shown at 202, and a downstream subsystem, generally shown at 204. The upstream subsystem 202 is configured to be coupled into a suitable access point in a fire main (for example the fire main 102 of FIG. 2). In this case, the access point is a fire main hydrant 114, which is coupled to the upstream subsystem 202 via a controllable isolation valve 206. Flow line 208 connects a water tank 210 to the fire main 102 via a high pressure diesel pump 212, an air driven pump 213. The high pressure diesel pump 212 is a positive displacement pump, which offers the operational advantage that it provides a consistent flow rate for the chemical treatment injection fluid. This avoids undesirable changes to the flow resulting from any unexpected pressure changes in the flow system.

In line with the flow line 208 is a chemical treatment unit. In this embodiment, chlorine dioxide (ClO₂) is used as a biocide instead of conventionally used chemical treatment materials, and therefore the chemical treatment unit is a chlorine dioxide generation unit 214. The chlorine dioxide generation unit 214 addresses some of the difficulties in dealing with chlorine dioxide by avoiding the transport and storage of pre-prepared chlorine dioxide solutions and instead providing an on-site facility for the generation of chlorine dioxide and dosing of water injected from the tank to the fire main. The chlorine dioxide generation unit 214 is operative to continuously generate chlorine dioxide from precursor chemicals and introduce it into the injection water fluid. The unit 214 comprises first and second pre-cursor source tanks and a reactor, and uses sulphuric acid (H₂SO₄) and a carefully controlled mixture of sodium chlorate (NaClO₃) and hydrogen peroxide (H₂O₂) as the precursor chemicals for the chlorine dioxide generation. A control system controls the influx of the reactants into the reactor in order to generate chlorine dioxide gas in the reactor chamber which is dissolved into the water flowing in the flowline 208. A suitable process is described in detail in international patent publication number WO 2003/000586 in the name of Akzo Nobel N. V.

Although the described sodium chlorate and sulphuric acid reaction scheme is preferred for reasons of safety and convenience, it will be appreciated that the invention extends to other chlorine dioxide generation processes. For example, other metal chlorates, and in particular alkali metal chlorates such as potassium, may be used to generate chlorine dioxide from chlorate ions. In addition, acids other than sulphuric acid may be used, including chloric acid or alternatively other mineral acids such as hydrochloric acid or nitric acid. Alternatively sodium chlorite and hydrochloric acid reaction schemes such as those described in U.S. Pat. No. 4,247,531 and U.S. Pat. No. 4,590,057 may be used, particularly where issues relating to corrosion or handling and storage of precursor chemicals are of less concern. In parallel with the water tank 210 and upstream of the high pressure diesel pump 212 is a gel tank 216, which is coupled into the flow line to permit gel to be pumped into the fire main 102. The gel is pumped by the high pressure diesel pump 212 in conjunction with an air driven cross linking agent pump 218 connected into the flow line 208 at a location near the coupling with the fire main. Therefore cross-linking of the gel (where required) may be initiated at a location close to the fire main 102, after transport though the majority of the upstream subsystem. The upstream subsystem 202 also includes a pressure reducing valve 220 and an associated overflow tank 222, which can be set to ensure that a maximum pressure is not exceeded in the subsystem. An instrumentation panel 224 connected into the upstream system provides a means for monitoring and controlling flow parameters in the subsystem.

The downstream subsystem 204 is configured to be coupled into a second access point of the fire main via a controllable isolation valve 230. As before, the access point is a fire main hydrant 114. Flow line 234 receives the flow from the fire main hydrant, and directs it to a choke manifold skid, generally depicted at 240. The choke manifold skid comprises two coarse filter flow lines 242a, 242b arranged in parallel to provide redundancy, each comprising coarse filters 243a, 243b and controllable chokes 244a, 244b. The filters 243a, 243b are configured to remove solid particles of around 2 to 3 mm from the fluid. The choke manifold skid 240 also comprises an emergency bypass line 246 through which flow can be diverted if it is necessary to rapidly bleed pressure from the system 204. An outlet 248 from the choke manifold skid leads to a water tank 210, which therefore functions as a circulation tank for the upstream cleaning system. The system also includes a waste tank 250, to which the effluent may be diverted from the outlet 248.

The cleaning system 200 also comprises a camera access point 226 in the fire main 102. This allows the chemical treatment process to be monitored in real time by visually inspecting the effect of the chemical treatment on the tuberculation in the fire main. The information gathered by the camera may be used to make operational decisions on the process, for example to adjust the flow parameters or chemical treatment dose during operations. Alternatively, the visual information may simply be used to verify or record the performance of the chemical treatment in a post treatment analysis step.

The cleaning system described above facilitates effective and efficient cleaning of a fire main associated with a water deluge system and a method of use will now be described.

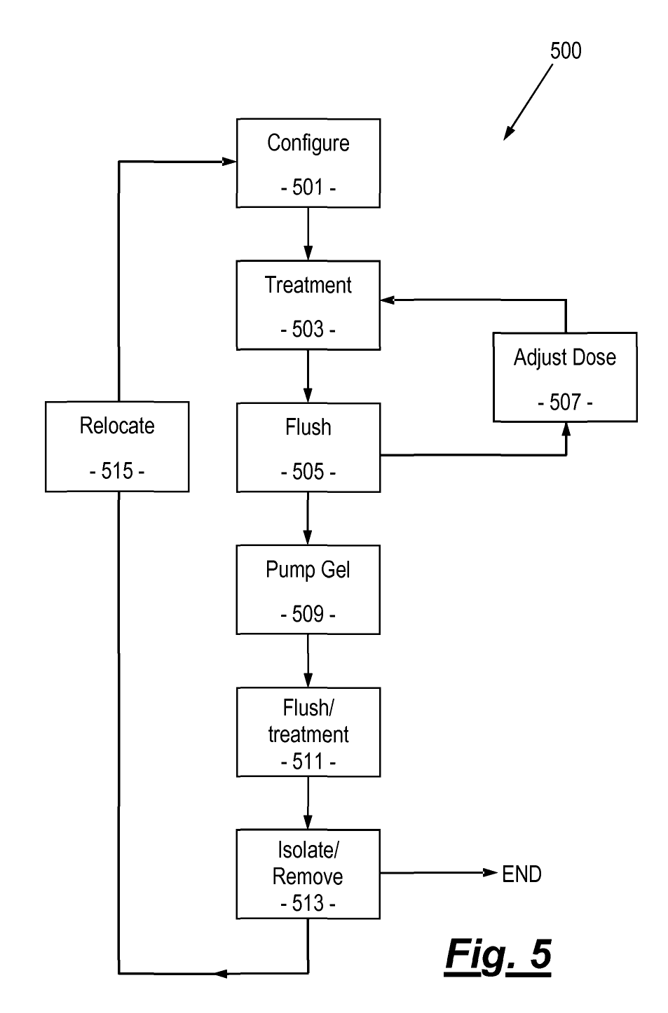

FIG. 5 is a block diagram showing selected method steps performed in a method of cleaning the fire main of FIG. 2, using the system of FIG. 4.

In a preliminary step (not shown) suitable tie-in points are identified for coupling the inlet and outlet flowlines 208, 234. The system 200 is configured (step 501) for attachment to the fire main 102 via the hydrants 114, and equipment and pressure tests are performed to check the proper functioning of the system and in particular the isolation valves 206, 230.

During treatment step 503, the upstream subsystem 202 is pressurised to a pressure above the fire main pressure (by about 200 kPA) by operating the air driven pump 213, and the valve 206 is slowly opened. The downstream 204 is then pressurised to a pressure above the fire main pressure (by about 200 kPA) by the air driven pump and the valve 230 is slowly opened. This establishes fluid communication between the upstream and downstream subsystems and the fire main.

The pump 212 is operated to cause water to be pumped from the tank 210 into the first hydrant 114a. In the downstream system, the choke (244a or 244b) on the active choke line (242a or 242b) is slowly opened, until a steady flow rate of around 40 litres per minute is attained. The pressure in the fire main 102 is therefore kept above the minimum fire main threshold, at around 800 kPa to 1000 kPa to prevent the fire pump 109 from being activated.

With the water flowing from the first hydrant to the adjacent hydrant at a steady rate, chlorine dioxide (ClO₂), which has been pre-generated onsite in the chlorine unit, is spiked into the injected water to form a concentration of injected fluid of 50 ppm. Dosage levels are monitored and recorded at the injection point and returns point and adjusted if required. The chlorine dioxide solution at the selected dose flows between adjacent hydrants for the required period, which may be based on a multiple of a calculated volume of the section. The concentration of ClO₂ is selected to limit the adverse effect on any personnel that might inadvertently come into contact with the solution. The chlorine dioxide solution comes into contact with the tuberculated inner wall of the fire main pipe, and interacts with the mounds of material by oxidising organic compounds in the biofilm. The chlorine dioxide effectively kills the microorganisms of the biofilm and begins to break down the tuberculation in the pipe.

Material that has been displaced by the biociding action is now contained in the water in the fire main. It is desirable to avoid flow of debris into the downstream subsystem, and therefore the choke operator will monitor the pressure levels and adjust the choke accordingly. Return fluid is recirculated into the fluid injection system via the tank 210.

When the correct dosage has been achieved and calculated treatment volume of fluid has been delivered, pumping is stopped and the choke operator closes in the choke while ensuring at least 500 kPa pressure remains in the system to prevent the fire pump from being triggered. Isolation valves 206 and 230 are then close to leave the solution in the fire main for a soak period of around 30 to 60 minutes.

In a subsequent step (step 505), the debris and material in the fire main is removed from the system by flushing (step 505). This is achieved by opening overboard dump outlet 111 and activating the fire pump 109. The fire pump is operated until the fire main is flushed and the material has been discharged from the fire main. Water from the fire main and the displaced material passes out the fire main for storage, treatment or discharge. It is one advantage of the present invention that the fluid may be discharged safely as it contains low levels of harmful contaminants, although where discharge is impractical or undesirable the fluid can be post-treated or stored.

The process described above removes a proportion of the tuberculation material on the innermost surface of the layer. However, it may not remove the tuberculation completely and therefore in preferred implementations of the invention, the sequence of steps 503 to 505 described above is repeated: water is injected through the first hydrant and is output from a second adjacent hydrant at a steady state; chlorine dioxide is added to the flow to create flow of chlorine dioxide solution between the first and second hydrants. However, in this second phase of chlorine dioxide treatment, the dose of chlorine dioxide treatment in the injected water is adjusted (step 507) to a lower concentration of ClO₂ than that used in the first treatment phase; 40 ppm rather than 50 ppm in this example. The lower concentration is selected to account for some of the tuberculation having been removed in the first phase. Not only does this reduce the required chlorine dioxide concentration for effective treatment during the second phase, but it also puts the inner steel wall of the pipe in closer proximity to the treatment chemical. By reducing the concentration, any negative effects of the chlorine dioxide on the pipe work materials are mitigated. Subsequent to the treatment, the system is flushed by activating the fire pump and discharging the fluid and dislodged materials through the overboard dump outlet.

In a next phase of treatment, the dose is adjusted again and the process steps 503 to 505 are repeated with a lower concentration of ClO₂, in this case 20 ppm. As before, the concentration is reduced to limit or prevent any adverse effects of the chemical treatment on the pipe material itself. The fluid and material is then flushed through the overboard dump outlet 111.

Subsequent to the third treatment phase, a debris pick-up gel, as is known the pipeline industry for cleaning or sweeping pipeline sections, is pumped (step 509) into the first hydrant and swept along the treated section to pick up materials present in the section which were not flushed out of the system. The gel is injected into the first hydrant and along the fire main to the second hydrant, picking up any remaining particles of material and removing them from the system. In this embodiment, the fire main is full of the gel between the first and second hydrants, although in other embodiments the gel may be pumped along as a shorter plug of fluid through the section being cleaned. The gel is received into a choke manifold skid via filters. Optionally, if a cross-linked gel is used for picking up debris, a cross-linking agent may be injected into the flow line via pump 218.

As final treatment of the section, the fire main is flushed again by activating the fire pump and opening the overboard dump outlet 111 (step 511).

When the treatment of one section is completed the isolation valves on the hydrants are closed and the equipment is decoupled (step 513). The equipment may be relocated (step 515) and configured to connect to another pair of inlets and outlets to the fire main, and the method may be repeated by coupling into the second hydrant 114b and a third hydrant 114c and repeating the steps outlined above.

Optionally, when all sections of the fire main have been treated in the manner described above, steps 503 and 505 are repeated over a larger section of the fire main (preferably as much of the fire main as can be treated in a single step). This provides a final treatment of the sections previously cleaned, although this time the selected dose of chlorine dioxide solution is 20 ppm. This provides for removal, flushing and discharge of any loosened materials from an extended section of the fire main.

It is desirable to monitor the effectiveness of the method in removing tuberculation from the fire main during the operation. In this embodiment therefore, the method includes the use of a camera inserted via camera access point 226 located between the two hydrants 114b and 114c.

The invention provides an apparatus for and method of cleaning a fire main associated with a deluge system. The method comprises injecting a chemical treatment fluid into the fire main via a first inlet and causing it to flow along a section of the fire main and out through an outlet while the fire main is in an operative condition associated with a deluge system. In one aspect, the method comprises biociding the fire main with a solution of chlorine dioxide to remove tuberculation from the fire main.

The invention provides apparatus for and method of cleaning existing fire main pipe work which does not suffer from drawbacks of the prior art. Normal operations of an offshore installation or vessel are minimally disrupted and/or may continue as it is not necessary to take a deluge system offline for maintenance or cleaning. The method and apparatus is suitable for cleaning and maintenance of fire mains which may be practiced in a wide range of industrial facilities, including offshore installations and vessels such as those used in the oil and gas industry.

Various modifications may be made within the scope of the invention as herein intended, and embodiments of the invention may include combinations of features other than those expressly claimed.

1. A method of cleaning a fire main associated with a deluge system, the method comprising:
coupling a fluid injection subsystem and a fluid collection subsystem respectively to an inlet and an outlet of a first pair of access points to the fire main;
injecting a chemical treatment fluid into the fire main and causing it to flow along a first section of the fire main via the inlet and outlet of the first pair of access points while the fire main is in an operative condition associated with a deluge system.

2. The method as claimed in claim 1 wherein at least one of the inlet and outlet of the first pair of access points is a fire main hydrant access point.

3. The method as claimed in claim 1 or claim 2 wherein the fire main access point is associated with a fire main isolation valve.

4. The method as claimed in claim 1 comprising coupling the fluid injection or collection subsystem to the access point; isolating the fluid injection or collection subsystem from the access point by closing an isolation valve in the fluid injection or collection subsystem; and/or opening an access point isolation valve.

5. The method as claimed in claim 1 comprising pumping the chemical treatment fluid into the fire main.

6. The method as claimed in claim 1 comprising choking the flow into the fluid collection subsystem from the outlet.

7. The method as claimed in claim 1 comprising pressurising the fluid injection and/or collection subsystem to a pressure above the operational pressure in the fire main, prior to fluidly connecting the fluid injection and/or collection subsystem to the fire main.

8. The method as claimed in claim 1 wherein the chemical treatment fluid comprises a biocide, and the method comprises biociding the fire main or a section of the fire main.

9. The method as claimed in claim 8 wherein the biocide comprises a solution of chlorine dioxide.

10. The method as claimed in claim 1 wherein the chemical treatment fluid comprises chlorine dioxide solution, and the method comprises generating chlorine dioxide and spiking an injection fluid to form a chlorine dioxide solution.

11. The method as claimed in claim 1 comprising soaking the first section of the fire main with the chemical treatment fluid.

12. The method as claimed in claim 11 comprising isolating the fluid injection subsystem and the fluid collection subsystem at the inlet and the outlet of the first pair of access points, while the chemical treatment fluid is in the fire main.

13. The method as claimed in claim 1 comprising flushing the fire main or a section of the fire main after injection of a chemical treatment fluid.

14. The method as claimed in claim 13, wherein flushing the fire main or a section of the fire main comprises activating a fire pump associated with the fire main to pump water through the fire main to a discharge outlet.

15. The method as claimed in claim 1 comprising operating a choke in the fluid collection subsystem to control fluid pressure during injection of the chemical treatment fluid into the fire main.

16. The method as claimed in claim 1 comprising repeating the injection of a chemical treatment fluid into the fire main.

17. The method as claimed in claim 16 wherein the injection of a chemical treatment fluid may be repeated for an additional one or more times at successively lower doses than previous chemical treatment fluid injections.

18. The method as claimed in claim 1 comprising passing a debris pick-up gel through the first section of the fire main.

19. The method as claimed in claim 18 comprising pumping a debris pick-up gel from a gel storage tank through the first section of the fire main to a waste collection tank in the fluid collection subsystem.

20. The method as claimed in claim 1 comprising coupling a fluid injection subsystem and a fluid collection subsystem respectively to an inlet and an outlet of a second pair of access points to the fire main; and injecting a chemical treatment fluid into the fire main causing it to flow along a second section of the fire main via the inlet and outlet of the second pair of access points.

21. The method as claimed in claim 20 wherein at least one of the inlet and outlet of the second pair of access points is a fire main hydrant access point.

22. The method as claimed in claim 1 comprising circulating fluid collected from the fluid collection subsystem into the fluid injection subsystem.

23. The method as claimed in claim 1 comprising inserting a camera into a section of the fire main and visually monitoring the chemical treatment process or results of the chemical treatment.

24. A system for treating a fire main associated with a deluge system, the system comprising:
a fluid injection subsystem and a fluid collection subsystem operable to be coupled respectively to an inlet and an outlet of a fire main while the fire main is in an operative condition associated with a deluge system; and
a pump for injecting a chemical treatment fluid into the fire main and causing it to flow along in the fire main from the fluid injection subsystem to the fluid collection subsystem.

25. The system as claimed in claim 24 wherein the fluid injection subsystem and/or the fluid collection subsystem are operable to be coupled to a fire main hydrant access point.

26. The system as claimed in claim 24 wherein the fluid injection subsystem and/or collection subsystem comprise an isolation valve.

27. The system as claimed in claim 24 wherein the fluid collection subsystem comprises a choke.

28. The system as claimed in claim 24 wherein the fluid injection subsystem comprises a biocide injection unit.

29. The system as claimed in claim 28 wherein the biocide injection unit is a chlorine dioxide injection unit.

30. The system as claimed in claim 29 wherein the chlorine dioxide injection unit comprises a chlorine dioxide generator.

31. The system as claimed in claim 24 comprising a debris pick-up gel injection means, and a debris pick-up gel collection means.

32. The system as claimed in claim 24 comprising a camera configured to be inserted into the fire main.
